(19) United States
(12) Patent Application Publication
(10) Pub. No.: US 2024/0409827 A1
(43) Pub. Date: Dec. 12, 2024

(54) PROCESS FOR THE PRODUCTION OF PYROLYSIS OIL FROM WASTE PLASTICS

(71) Applicant: SHELL USA, INC., Houston, TX (US)

(72) Inventors: Guus VAN ROSSUM, Amsterdam (NL); Timothé Johannes OLTHOF, Amsterdam (NL); Jose Atilio QUEVEDO ENRIQUEZ, Amsterdam (NL)

(21) Appl. No.: 18/695,552

(22) PCT Filed: Oct. 12, 2022
(86) PCT No.: PCT/EP2022/078323

§ 371 Date: Mar. 26, 2024

(30) Foreign Application Priority Data
Oct. 18, 2021 (EP) 21203257.7

(51) Int. Cl. C10G 55/04; B01D 3/34; B01D 11/04; B09B 3/35; B09B 3/40; B09B 3/80; B09B 101/75; C10B 53/07; C10B 57/10; C10G 9/36

(52) U.S. Cl. CPC C10G 55/04; B01D 3/346; B01D 11/0488; B01D 11/0492; B09B 3/35; B09B 3/40; B09B 3/80; C10B 53/07; C10B 57/10; C10G 9/36; B09B 2101/75; C10G 2300/1003

(57) ABSTRACT

The invention relates to a process for converting plastics waste into pyrolysis oil for feeding to a steam cracker including the steps of: pre-washing a stream of comminuted waste plastics in a washing liquid comprising washing water and caustic solution; separating the pre-washed comminuted waste plastics to provide a stream of polyolefin-enriched washed comminuted plastics waste; thermally cracking the stream of polyolefin-enriched washed comminuted plastics waste to produce a vaporised hydrocarbon stream; condensing the vaporised hydrocarbon stream into a liquid hydrocarbon stream and gaseous hydrocarbon stream; washing the liquid hydrocarbon stream with caustic solution; separating the liquid hydrocarbon stream from the caustic solution to produce a stream of caustic-washed liquid hydrocarbon and a stream of spent caustic solution; and rinsing the caustic-washed liquid hydrocarbon stream with water; separating the rinsed liquid hydrocarbon stream from the rinsing water to produce a stream of pyrolysis oil and a stream of spent water.

### FIELD OF THE INVENTION

The present invention relates to a process for producing pyrolysis oil from waste plastics, and to a process for steam cracking a hydrocarbon feed which feed comprises the pyrolysis oil recovered in the above-mentioned process.

### BACKGROUND OF THE INVENTION

The circular economy represents an alternative, more sustainable model to the traditional linear economy. The unique characteristics of plastics, being lightweight, versatile, and durable, have resulted in them becoming key materials in many industrial sectors, including packaging, building and construction, automotive and renewable energy, to name but a few. Many plastics do not readily degrade, for example, plastics placed in landfill may take hundreds of years to degrade, plastic bottles are also similarly resistant to degradation even when exposed to the atmosphere, while plastic bags can take 10-20 years to decompose. Plastics waste that does not end up in landfill remains a hazard if ingested and can end up in waterways and oceans where it poses a threat to marine life. Even so-called biodegradable plastics can remain intact for many years before breaking down and remain a threat to wildlife and ecosystems in the meantime.

Accordingly, there is a continued need to reduce the environmental impact of plastics, either by finding alternative, sustainable materials or by recycling or re-processing plastics materials that have outlived their usefulness. Improving the circularity of plastics by recovering plastics waste and transforming the waste into useful new products leads to a reduction in the volume that ends up in landfill or would otherwise contribute to environmental pollution.

In recent years, processes have been developed for converting waste plastics into pyrolysis oil. Such processes may involve preparation of feedstock from the plastics waste in order to transform it into a form suitable for steam cracking. Preparation of the feedstock may be energy intensive and also require high volumes of water and/or chemicals, thereby not only making the financial cost of processing of plastics waste unattractive but adding to the environmental cost through heavy use of energy and other resources.

WO2018069794 discloses a process for producing olefins and aromatic hydrocarbons from plastics wherein a liquid pyrolysis product stream is separated into a first fraction having a boiling point <300° C. and a second fraction having a boiling point 2300° C. Only said first fraction is fed to a liquid steam cracker, whereas said second fraction is recycled to the pyrolysis unit. In the process shown in FIG. 1 of WO2018069794, said separation is performed in a hydrocarbon liquid distillation unit. Having to separate the liquid pyrolysis product stream into two fractions is cumbersome (e.g., energy intensive). A further disadvantage is that the heavier portion of the liquid pyrolysis product stream has to be sent back to the pyrolysis unit for a deeper pyrolysis. This results in yield loss through the formation of gas and an increasing amount of solid side-product (coke) which is eventually not sent to the steam cracker. In one embodiment of the process of above-mentioned WO2018069794 (see FIG. 2), the first fraction having a boiling point <300° C. is first conveyed together with hydrogen to a hydroprocessing unit to produce a treated hydrocarbon liquid stream which is then fed to the liquid steam cracker. Such hydroprocessing is also cumbersome, as it is both capital and energy intensive and requires the use of expensive hydrogen (H₂).

There is an ongoing need to develop improved processes for the recovery of olefins from liquid hydrocarbon streams originating from cracking waste plastics, especially before feeding such recovered hydrocarbons to a steam cracker. It is an object of the present invention to provide such a process in a technically advantageous, efficient and affordable manner.

### SUMMARY OF THE INVENTION

Surprisingly it was found by the present inventors that such a process can be provided by re-using spent streams of processing water and caustic solution from downstream steps of the process in a plurality of upstream steps. A “spent” stream as used herein is a stream which contains a level of undesirable components such that it may no longer be recycled for use in its original step.

Accordingly, from a first aspect, the present invention relates to a process for converting plastics waste into pyrolysis oil for feeding to a steam cracker, said process comprising the steps of:
a) pre-washing a stream of comminuted waste plastics in a washing liquid comprising washing water and caustic solution;
b) separating the washed comminuted waste plastics to provide a stream of polyolefin-enriched washed comminuted plastics waste;
c) optionally drying the stream of polyolefin-enriched washed comminuted plastics waste;
d) thermally cracking the stream of polyolefin-enriched washed comminuted plastics waste to produce a vaporised hydrocarbon stream;
e) condensing the vaporised hydrocarbon stream into a liquid hydrocarbon stream and gaseous hydrocarbon stream;
f) washing the liquid hydrocarbon stream with caustic solution;
g) separating the liquid hydrocarbon stream from the caustic solution to produce a stream of caustic-washed liquid hydrocarbon and a stream of spent caustic solution; and
h) rinsing the caustic-washed liquid hydrocarbon stream with water;
i) separating the rinsed liquid hydrocarbon stream from the rinsing water to produce a stream of pyrolysis oil for further processing by steam cracking and a stream of spent water,
   wherein:
a first portion of the spent water stream from step i) is used as wash water in step h) and a second portion of the spent water stream from step i) is used as washing water in step a), and
a first portion of the spent caustic solution from step g) is used as caustic solution in step f) and a second portion of the spent caustic solution from step g) is used as caustic solution in step a).

Advantageously, in the present invention, as a result of the various cleaning steps, and especially the removal of contaminants through pre-washing of the comminuted waste plastics and washing of the pyrolysis oil with a caustic solution, the pyrolysis oil produced is of high quality with contaminants in concentrations such that the stream is suitable for feeding to a thermal/steam cracker or, if it does not fully meet the specification for the cracker, the amount of subsequent processing of the pyrolysis oil to reduce the impact on the cracker is substantially reduced.

In addition to producing a high quality pyrolysis oil, the present invention requires reduced input of water and caustic through countercurrent re-utilisation in upstream steps of used or spent washing or rinsing streams produced in downstream process steps. The upstream steps that re-use washing or rinsing streams are tolerant of higher contaminant loading than the downstream step where fresh caustic solution and water are used.

The process may be conducted as a batch process, but advantageously is conducted as continuous process.

### BRIEF DESCRIPTION OF THE DRAWINGS

FIG. 1 provides a schematic diagram of an illustrative embodiment of a process according to the present invention for converting plastics waste into pyrolysis oil.

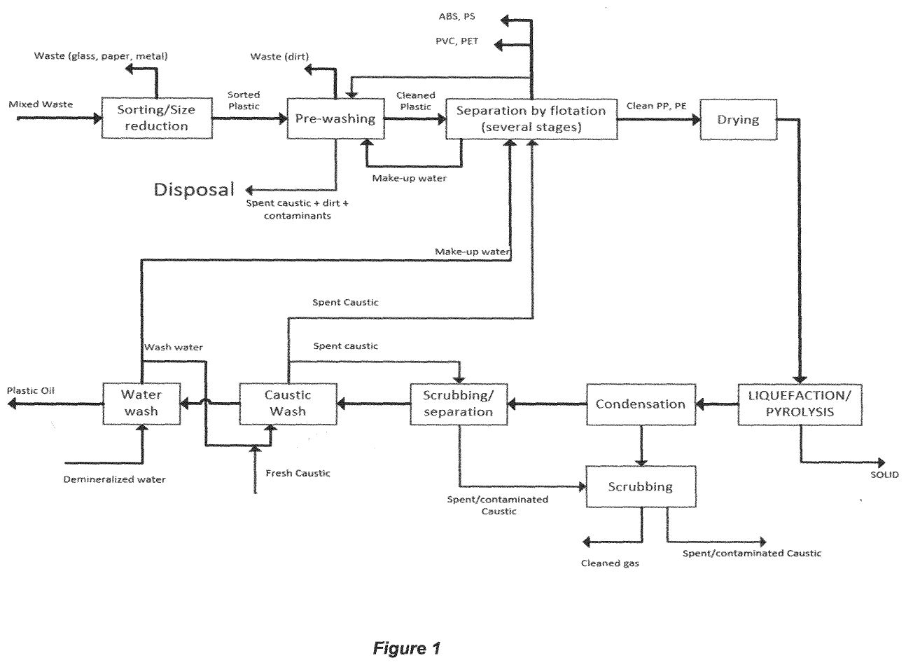

### DETAILED DESCRIPTION OF THE INVENTION

The written disclosure herein describes illustrative embodiments that are non-limiting and non-exhaustive. The process of the present invention comprises multiple steps. In addition, said process may comprise one or more intermediate steps between consecutive steps. Further, said process may comprise one or more additional steps preceding the first step and/or following the last step. For example, in a case where said process comprises steps a), b) and c), said process may comprise one or more intermediate steps between steps a) and b) and between steps b) and c). Further, said process may comprise one or more additional steps preceding step a) and/or following step c).

Within the present specification, a phrase like “step y) comprises subjecting at least part of the stream resulting from step x) to” means “step y) comprises subjecting part or all of the stream resulting from step x) to” or, similarly, “step y) comprises partially or completely subjecting the stream resulting from step x) to”. For example, the stream resulting from step x) may be split into one or more parts wherein at least one of these parts may be subjected to step y). Further, for example, the stream resulting from step x) may be subjected to an intermediate step between steps x) and y) resulting in a further stream at least part of which may be subjected to step y).

While the process(es) of the present invention and the stream(s) and composition(s) used in said process(es) are described in terms of “comprising”, “containing” or “including” one or more various described steps and components, respectively, they can also “consist essentially of” or “consist of” said one or more various described steps and components, respectively.

In the context of the present invention, in a case where a stream comprises two or more components, these components are to be selected in an overall amount not to exceed 100%.

Further, where upper and lower limits are quoted for a property then a range of values defined by a combination of any of the upper limits with any of the lower limits is also implied.

In some embodiments, for providing a source of waste plastics for use in the process of the present invention, separation from other foreign materials, such as glass, stone, metal, paper, and other debris may be performed prior to the step of size reduction. Typically, waste plastics may be collected along with other refuse materials and stockpiled at a refuse storage facility where separation can take place. Removal of much of the non-plastics materials from a waste source may be achieved by known means, such as by use of magnets to extract magnetic metals, eddy current sorters to extract non-magnetic metals, especially aluminium, and shakers, screens, and pneumatic blowers to extract paper and other debris. Following removal of at least some if not all the non-plastics materials, the residual plastics waste may be in the form of sheets, drums, rolls, blocks, containers, bottles, etc. having a multitude of sizes, weights, and densities.

Not all plastics waste is suitable for recovery of aliphatic hydrocarbons via pyrolysis, therefore in some embodiments the plastics waste may itself be further sorted to remove undesirable plastics materials, such as PVC or PET, prior to processing the waste plastics for conversion into a hydrocarbon stream. Removal of at least some undesirable plastics materials may be performed prior to the step of size reduction. For example, known techniques such as IR spectra analysis may be used in an automated recycling sorting process to separate and remove unwanted plastics materials, such as PVC and PET, leaving a waste stream enriched in desired polyolefin-based plastics for processing into pyrolysis oil.

Plastics waste that includes a substantial proportion of plastic bags or other lightweight plastics sheet or film materials may hinder efficient processing. Thus, in some embodiments it is preferred to densify plastic bags and the like prior to processing the waste, especially prior to size reduction. For example, waste plastic bags and other such lightweight plastics materials may be densified, such as by passing through a bag press feeder where the bags, etc. are compressed to form a higher density material prior to being recombined with other plastics waste for processing according to the invention.

In various embodiments, size reduction or comminution of the waste plastics materials is advantageously performed on an enriched polyolefin-based plastics stream. In this way, energy is not wasted on reducing the size of bulk plastics waste of which a significant proportion may not be useful for pyrolysis to produce liquid hydrocarbons. In the size reduction step, the waste plastics stream may be comminuted in one or more stages in which the materials are progressively reduced in size. The size reduction is preferably performed such that the diameter of the comminuted plastics waste is reduced to an average piece size of about 10 mm or less. For example, materials may first be reduced to pieces between 5 mm and 100 mm average diameter, then further reduced to pieces with an average diameter size of between 30 mm to 40 mm, and finally reduced to an average diameter size of about 5 mm to 10 mm. The average diameter size of the comminuted plastics materials may be determined using conventional measuring techniques known in the art, such as those involving shakers and vibrators.

Size reduction may be performed using apparatus such as granulators, crushers, milling machines and the like. The materials may be reduced in size, for example, by grinding, chipping, pelletising, granulating, flaking, powdering, shredding, or milling. In some instances, crushing the material whereby the plastics waste is reduced to pieces having an average diameter size of 25 mm or less, typically an average diameter of between 15 mm and 25 mm, is sufficient for use in the steps downstream.

In some embodiments, the comminuted plastics waste may be transported directly to a washing facility for pre-washing, or may be held temporarily in storage, such as in a vessel or silo, prior to pre-washing. Transporting the comminuted waste, whether for pre-washing or storage, may be by pneumatic transport, mechanical transport, or liquid transport, the latter when the waste is carried in slurry form. Apparatus for such transportation may include conveyor belts, Archimedes' screws, piping, etc.

After size reduction, the resulting comminuted plastics waste may be subject to a pre-washing step. Pre-washing is desirable when the collected plastics waste material is contaminated by dirt and other foreign matter. Pre-washing may be performed by means of friction/vibration in washing water. Commonly, waste plastics materials are contaminated with glues and/or oils which are not soluble in water, thus use of a caustic washing water is preferred, and more preferably a heated caustic washing water is used. For example, the heated caustic wash may be operated at temperatures between about 40 and 120° C.

Advantageously, the washing water for pre-washing the comminuted waste plastics comprises, and more preferably consists of, spent wash water (otherwise referred to as make-up water) and/or spent caustic solution recycled from one or more downstream processing steps. Thus, the pre-washing stage does not require use of fresh water or fresh caustic solution but instead may rely entirely on make-up water and/or spent caustic solution from the rinsing step and/or caustic washing step used to clean the condensed liquid hydrocarbon stream obtained from thermal cracking of the polyolefin-enriched comminuted plastics waste.

The pre-washing step may be performed by means of known friction/vibrating cleaning machines and the like which utilise a washing liquid. As a result of pre-washing, any dirt and other contaminants become suspended or dissolved in the washing water, preferably in the caustic washing water. The pre-washed comminuted plastics waste is then separated from the washing water.

In various embodiments of the invention, the spent washing water from the pre-washing step may be further recycled after removal of heavy dirt material or may be directed for appropriate disposal such as when the level of dirt and contamination is high. In any event, the spent washing water from the pre-washing step will have been additionally used in one or more downstream steps of the process thus contributing to the economy and environmental credentials of the inventive process.

Advantageously, after use in the pre-washing step the spent washing water is fed to a washing water treatment system which may comprise one or more sedimentation tanks. In the tank(s), dirt and other debris washed from the comminuted plastics waste may be separated from the washing water as slurry and sent for further treatment and/or concentration prior to disposal. The spent washing water having had heavier dirt/debris removed may be recycled for re-use in the pre-washing step alongside washing water recycled from one or more downstream steps.

Following pre-washing, the comminuted plastics waste may be separated to provide a stream of polyolefin-enriched comminuted plastics waste. Separation of polyolefin-based plastics from other plastics may, for example, be performed by techniques involving density, lixiviation or flotation. Utilising differences in buoyancy (density), with polyolefin-based plastics typically being less dense than other types, is advantageous. For example, the pre-washed comminuted plastics waste may be passed through a series of flotation tanks containing water and/or salted water of gradually increasing density. In some embodiments, the water and/or salted water used in the separation by flotation of the pre-washed comminuted plastics waste may comprise spent wash water (make-up water) and/or spent caustic solution recycled from downstream steps of the inventive process.

In one embodiment, the pre-washed comminuted plastics waste stream is passed to a first flotation tank containing make-up (or spent) water recycled from the downstream water wash step in which recovered hydrocarbons from the cracked waste plastics material are washed to remove traces of caustic prior to feeding to a steam cracker for further processing. Any subsequent flotation tanks containing salted water (caustic solution) may be fed with spent caustic solution from the downstream caustic wash step in which recovered hydrocarbons from the cracked waste plastics material are washed to remove residual contaminants or components that are not desirable in a steam cracker feed. Advantageously, separation of polyolefin-based plastics from other plastics by flotation is achieved using only make-up water and/or spent caustic solution. In this way, the separation step is reliant only on recycled water and/or caustic solution from downstream step(s) and does not require a feed of fresh water or fresh caustic solution.

In some embodiments, both the pre-washing liquid and the flotation liquid can be sourced from downstream steps of the process, making for an economical and efficient use of resources. For example, in one arrangement, the pre-washing liquid comprises, or may consist of, flotation liquid discharged from the flotation tank(s). Thus, the second portion of spent water from step i) and the second portion of spent caustic solution from step g) may first be used in the downstream separation step b) prior to being used to make up the washing liquid in the upstream pre-washing step a).

According to an embodiment, polyethylene (PE) (density 0.86 kg/m3) and polypropylene (PP) (density approx. 0.92 kg/m³) may float to the surface of a first sedimentation tank, while denser plastics such as polyvinylchloride (PVC) (density approx. 1.38 kg/m³), polystyrene (PS) (density approx. 1.05 kg/m³) and polyethylene terephthalate (PET) (density approx. 1.38 kg/m3) sink to the bottom of the tank.

One or more further sedimentation tanks may be utilised to separate the denser waste plastics, for example, to separate ABS and PS from PVC and PET. These non-polyolefin-based waste plastics, having been separated from the polyolefin-based waste plastics, may be transported for separate processing outside the scope of the present invention.

Adjusting the separation performance of the sedimentation tank(s) may be achieved by controlling the temperature of the water and/or salt solution as an alternative to controlling the salt concentration. For example, water at a temperature at or approaching boiling point (100° C.) may successfully separate PE and PP from other plastics.

Importantly, the water and/or caustic solution used in the step(s) of flotation separation comprises spent rinsing water and/or spent caustic wash solution from steps downstream thus substantially reducing the utilisation of water and caustic solution across the entire recycling process.

In an embodiment, the pre-washed comminuted plastics waste may be processed through three flotation tanks resulting in three streams of plastic pieces, namely a stream of light plastics (mainly polyolefins, including PE and PP), a stream of a mixture of light and heavy plastics (mainly ABS, PS, PE and PP) and a stream of heavy plastics (mainly ABS, PS, PET and PVC). Each stream extracted from the flotation tanks may be subjected to at least partial drying to have their water content removed or reduced. For example, reducing water content may be achieved through centrifugation, vibration or blowing.

The stream of light plastics may still contain light contaminants, such as from labels that were adhered to the plastics, and if present such contaminants may be removed at this stage, for example, by pneumatic separation. Further light plastics, contained within the stream comprising a mixture of light and heavy plastics, may be recovered by drying said stream and separating the PE and PP by passing the dried stream through an electrostatic sorting system. Typically, the electrostatic sorting system separates the dried mixed stream into three sub-streams comprising PE/PP, ABS and PS. The PE/PP from the mixed stream may then be combined with that from the light stream.

Thereafter, the separated pre-washed comminuted plastics waste comprising predominantly polyolefins, such as PE and PP, may be dried before being subjected to thermal cracking. Drying can assist in the removal of any residual dirt that might remain entrained on the surface of the waste. Such drying may be performed, for example, by means such as centrifugation, screw pressing, blowing with hot air, etc. If thermal cracking is conducted by hydrothermal liquefaction, drying is optional, but is advantageous for the purpose of removing any residual dirt.

An advantage of the process of the invention is that rinsing of the pre-washed comminuted plastics waste is not necessary because any caustic solution that remains or dries on the surface of the pre-washed comminuted plastics waste is well tolerated in subsequent processing steps, especially during thermal cracking by pyrolysis. For example, any remaining caustic solution may react with any residual contaminants remaining on the plastics to form salts which subsequently precipitate.

Following the steps of pre-washing, separation and drying (if required), the resulting cleaned, dried waste plastics enriched in polyolefins is suitably prepared for thermal cracking to produce a hydrocarbon stream.

Thermal cracking of the polyolefin-enriched waste plastics may involve the steps of melting, vaporisation, catalytic cracking, condensation and cleaning.

In one arrangement, a polyolefin-enriched waste plastics stream may be fed to an airlock feeder, upstream of the thermal conversion feeder, for reducing the amount of air entrained in the plastics stream prior to melting.

Optionally, the waste plastics may be pre-heated before melting, such as by contacting the waste plastics with a supply of steam. The waste plastics may be pre-heated to about 120 to 150° C. at which temperatures the plastics may become fully dried and compacted.

The melting of the polyolefin-enriched waste plastics may be performed by means of a thermal conversion process feeder prior to the melted waste being vaporised.

In one arrangement, the thermal conversion process feeder may comprise an extruder. Typically, melting of the plastics waste in an extruder occurs at temperatures in the range of about 250 to 320° C.

Alternatively, the plastics waste may be melted in a melting tank. A melting tank may be provided with an agitator as well as a scraper for maintaining the inner surface of the tank clean to enable efficient heat transfer, especially when heat is supplied to the tank via a heating jacket or the like.

Further heating of the melted plastics waste may be performed, if necessary, to raise the temperature closer to that required for thermal cracking. For example, melted plastics waste from the extruder or from the melting tank, may be fed to the vaporisation (pyrolysis) chamber via a series of heat exchangers, such as tubular heat exchangers, where molten plastics material is circulated and is further heated, for example by thermal oil or other suitable heating medium, to raise the temperature of the melted waste. For example, circulating the molten waste through heat exchanges may increase the temperature of the waste to about 380° C. or higher.

In another arrangement, the temperature of the molten plastics waste may be increased to approach the desired vaporisation temperature by contacting the molten waste with a liquid stream recycled from the vaporisation reaction. For example, in a pyrolysis chamber, liquid and/or solid may accumulate and this may be drained from the chamber for recycling with fresh molten plastics, preferably after any solids (if present) have been at least partially removed. The “fresh” molten plastics and recycled liquid stream from the pyrolysis chamber may be combined in a further heat exchanger, such as a tubular heat exchanger, prior to feeding the mixture to the pyrolysis chamber. In the pyrolysis chamber, the mixture may be heated to a temperature suitable for thermal cracking, typically in the region of about 400° C.

The resulting molten waste plastic material rich in polyolefins is thermally cracked to produce a hydrocarbon stream. The hydrocarbon stream may comprise a gaseous hydrocarbon stream, such as a first vapor hydrocarbon stream, which is subject to condensation in a later process step.

Thermal cracking may be conducted by pyrolysis or by hydrothermal liquefaction.

In a pyrolysis process, the molten stream of material is fed in to one or more reactors, otherwise referred to as pyrolysis chambers.

Pyrolysis is advantageously conducted in an inert atmosphere. Accordingly, the reactor(s) may be evacuated of oxygen by means of a nitrogen purge. The molten waste plastics is preferably fed into the reactor once the reactor has been purged of oxygen.

The operating temperature for the pyrolysis of the waste plastic material is generally in the range of from 250° C. to 450° C., preferably from 300° C. to 430° C., and most preferably from 350° C. to 400° C.

The reactor or reactors may comprise a heating source, such as in the form of a refractory chamber surrounding the reactor where a burner is fired, or the reactor may be provided with a heating jacket through which a hot thermal fluid is circulated, or the reactor may be provided with electrical heating elements.

The reactor may be provided with agitation means, preferably an anchor type impeller that ensures swiping of the internal vessel wall. However, the impeller is typically located at an elevation such that there is a volume underneath where debris and solid contaminants that do not volatilise due to their nature collect.

A second non-vapor pyrolysis stream resulting from pyrolysis of the molten waste plastics material may also be formed. For example, the second stream may comprise char which settles at the bottom of the reactor, along with other debris and contaminants, and from where it may periodically be removed. Char may be removed from the bottom of the pyrolysis chamber as a friable fine black powder.

In one arrangement, the pyrolysis chamber may include a reflux column on top of the reactor, otherwise referred to as a cracking tower. The reflux column may extend the residence time of heavy, long chain, hydrocarbons by condensing them and returning them to the vaporization reactor.

The vaporization reactor may be operated at a pressure below atmospheric for reducing the residence time of the hydrocarbons in the vaporization reactor and reducing the thermal cracking and the production of light, undesirable, hydrocarbons, such as methane.

An alternative approach for processing the polyolefin-enriched comminuted waste plastics material may comprise conducting all the steps of feeding, melting, heteroatom scavenging, pyrolysis and vaporization in an extruder reactor, the reactor having an internal auger/screw that transports the waste plastics material sequentially through a plurality of zones where each of the aforementioned steps may be conducted. Thus, the reactor extruder may for example comprise the following zones: a raw material feed zone, a compression zone, a melt zone, a mixing and destabilization zone with heteroatom scavenging, a pyrolysis zone, a devolatilization zone and a char discharge zone. In use, shredded waste plastic material enriched in polyolefins is fed to the extruder, preferably in combination with a liquid or a mineral-based additive or a melt-phase catalyst. As the mixture is conveyed further by the auger, it is then compressed whilst being heated, and provision of a venting section in or near the compression zone allows trapped air to escape. Then, the mixture continues being heated until melting and then is further heated to a temperature at which thermal cracking commences and heteroatoms are removed. The remaining melt is conveyed to the pyrolysis zone where it is further cracked. The vapours that are released from the extruder during pyrolysis are captured for recovery by condensation and residual solids are conveyed in the extruder where they undergo further de-volatilization before exiting the reactor extruder as a solid residue.

In the step of thermal cracking, the melted waste plastic material rich in polyolefins volatilizes into a hydrocarbon stream which is passed through a catalytic converter where the hydrocarbon vapours may be further cracked into a lighter hydrocarbon stream. The catalytic converter preferably comprises catalyst on a support, typically supported on plates or tubes to provide an increased contact area. The catalyst support may be heated to maintain a temperature in the range of 220° C. to 450° C.

The catalyst may be selected for cracking carbon paraffinic chains longer than C25 and reforming chains shorter than C6. The catalyst may also influence the conversion of alpha-olefin chains (1-alkenes) to saturated alkanes. Advantageously, the catalyst is selected such that the resulting fuel has a carbon chain distribution in the range C9-C25, preferably peaking at C16 (cetane).

The catalyst may comprise a silica carrier on which is carried active ingredients such as one or more metals, rare earth elements, barium, phosphorous among others. The catalysts preferably include metal catalysts, especially based on metals including Ni and Cu, or ceramics or zeolites in shape of punched plate and wire mesh type. Other catalysts may include MCM-41 and silicates of iron Fe3+, cobalt Co2+, nickel Ni2+, Raney nickel, manganese Mn2+, chromium Cr3+, copper Cu2+and/or mixtures thereof. The catalytic plates may be made from any one of these metals, or a combination thereof.

The catalysts and the cracking processes are well-known in the art. For example, technology based on use of a catalytic tower is widely known in the petrochemical industry and details concerning the same are found in prior art, for example, in published application JP 2000109949 A.

In an alternative embodiment, instead of having the catalyst embedded on the surface of packing material as in the catalytic converter previously mentioned, the catalyst may be added to the vaporization reactor in the form of particles. Such a heterogeneous catalyst may, for example, be in pure form of may be embedded on a solid carrier. When added to the vaporization reactor, the catalyst is heated to a temperature in the range of from 100 to 500° C.; and in a solid catalyst particle to plastic mass ratio in the range of from 0.2 to 20 times. The residence time of the heterogeneous catalyst particles in the reactor may be in the range of from 1 to 6000 seconds. Furthermore, contacting of the molten plastic waste with the solid catalyst particles may be carried out in a riser or a downer configuration, for example as part of a fluid catalytic cracking (FCC) type arrangement where the particles are like FCC catalyst.

Another alternative approach, as previously mentioned, is to conduct the melting, vaporization and cracking in an extended extruder. Such an extruder is provided with augers that are specially designed to accommodate the production of vapours.

In yet another approach, the reactor may be of the rotary type comprising different heating zones and with the possibility of catalyst addition to facilitate selective cracking of the plastics or removal of contaminants. The cracked hydrocarbon vapours may then be passed through a cyclone for particulate removal and then through one or more catalyst towers where the vapours are further cracked into specific hydrocarbon cuts. Then, the resulting hydrocarbon stream may undergo separation by distillation.

Instead of thermal cracking by pyrolysis, a hydrothermal liquefaction (HTL) process may alternatively be used. While HTL may be performed without drying of the polyolefin-enriched comminuted plastics waste, inclusion of a drying step may lead to an improved product. Hydrothermal liquefaction is itself a known method of thermal depolymerization. In one such example, hydrothermal liquefaction may include the following steps: melting of polyolefin-enriched comminuted plastics waste in an extruder, optionally injecting a solvent, and contacting the extruded plastics waste with water at supercritical conditions to form an aqueous slurry. A catalyst for assisting the cracking of the plastics waste may be added to the waste by feeding the waste and catalyst into the extruder simultaneously.

The process may involve use of a base catalyst, such as sodium hydroxide or the like. Typically, the weight ratio of the extruded material to aqueous solvent is in the range from 0.5-12, and more especially in the range of from 0.5 to 4. The pressure and temperature at the end of the extruder may typically reach 180 barg and 200° C.

The extruded solvent-plastics mixture may then be introduced in a hydrothermal reactor where supercritical conditions are maintained and a residence time sufficient to carry out cracking is permitted. For example, the temperature range in the hydrothermal reactor may be from 150° C. to 400° C. and the pressure up to 350 bar. The residence time in the hydrothermal reactor may be in the range of from 5 to 60 minutes.

In known processes involving hydrothermal liquefaction, the product from the reactor is typically depressurized, cooled, and separated to produce different hydrocarbon cuts. However, when hydrothermal liquefaction is used for thermal cracking in the process of the invention, such separation is not required since the whole product stream may be subjected to condensation in a downstream step.

In the step of thermal cracking, whether by pyrolysis or hydrothermal liquefaction, the plastics waste is cracked and converted to oligomers that are vaporised. Oligomers that have chain lengths too large or too short to be useful may be returned to the reactor for further processing.

The vaporised hydrocarbon stream obtained from the cracking step may be separated into liquid and gaseous hydrocarbon streams in a condensation step.

The condensation step may be performed in a variety of different approaches. For example, when the vaporised hydrocarbon stream is produced using a catalytic converter/cracker, the light hydrocarbon stream from the catalytic converter/cracker is subjected to cooling prior to separation into liquid and gaseous hydrocarbon streams. Typically, the condensation temperature may be in the range of from 150° C. to 250° C.

Means for cooling may be provided by heat exchangers where the cooling media is integrated with other parts of the process. For example, when thermal oil is used as a heating fluid for melting the plastics waste, cooled thermal oil exiting the extruder may be used as cooling media for the condensation. If needed, further cooling of the light hydrocarbon stream can be performed according to methods known in the art, for instance by means of air coolers, or heat exchangers supplied with cooling water.

The cracked hydrocarbon vapours may alternatively be condensed using a distillation column for quenching and separation. For example, the vaporised hydrocarbon stream may be introduced into a distillation column provided with one or more circulating refluxes or pumps. The recirculated streams remove heat contributing to the condensation of hydrocarbons.

In some embodiments, following condensation of the vaporised hydrocarbon stream, the resulting condensed liquid and non-condensed gaseous hydrocarbon streams may optionally each be subjected to a scrubbing step. The scrubbing of the liquid and/or gaseous hydrocarbon streams may be performed by bringing the streams into contact with a scrubbing liquid.

The scrubbing liquid may comprise spent caustic solution from a downstream step of the process of the invention. For example, the condensed hydrocarbon liquid stream may be fed to a first scrubber for contact with spent caustic solution from a downstream step, and preferably also subjected to steam stripping to adjust the flash point of the liquid to about 60° C. or above to fulfil storage requirements. Any light hydrocarbon components stripped/separated from the condensed liquid stream in the first scrubber may be fed to a second scrubber, upstream of the first scrubber, where it is combined with the stream of non-condensed hydrocarbon gases.

In the second scrubber, the non-condensed hydrocarbon stream and any light hydrocarbon components stripped from the first scrubber upstream are scrubbed by contact with an aqueous solution with an adjusted pH to remove undesirable acid and toxic compounds. The pH adjusted aqueous solution comprises spent/contaminated aqueous caustic solution discharged from the first scrubber. The spent/contaminated caustic solution in the second scrubber may be pH adjusted, for example, by addition of acid.

The second scrubber may comprise a scrubbing tower where the vapor stream contacts a scrubbing solution into which contaminants are absorbed or may comprise a scrubbing tank into which the vapour stream is bubbled. The scrubbed vapor exiting the second scrubber may then be used as a source of fuel gas. The spent/contaminated caustic solution from the second scrubber may be sent for incineration or other disposal, but it will have been utilised in at least two upstream steps beforehand, making the entire process environmentally and economically effective by reducing the volume of fresh caustic solution required to be input into the process.

The steps of condensation and scrubbing in the first scrubber may result in the temperature of the condensed, scrubbed hydrocarbon liquid being lowered from the condensation temperature to a temperature appropriate for subsequent washing of the condensed hydrocarbon stream. Typically, the condensed hydrocarbon liquid may have a temperature in the range of from 100° C. to 250° C. following condensation and scrubbing.

In various embodiments, the condensed hydrocarbons recovered from the thermal cracking of the waste plastics may be washed with caustic solution to remove contaminants or other components that might be detrimental if subsequently fed to a steam cracker.

The washing of the condensed liquid hydrocarbon stream derived from thermal cracking with caustic solution may be performed in one or more stages. Where more than one caustic washing stage is desired, each stage may make use of caustic solutions of differing concentrations and/or different condensed hydrocarbon to washing solution ratios. In the or each washing stage, the condensed hydrocarbon stream may be brought into contact with caustic washing solution by means well known in the art such as, but not limited to, passing through a throttling valve and/or a static mixer, stirring, jetting, etc. Phase separation of the washed condensed hydrocarbon stream and the caustic solution may be achieved by known methods, for example, by decanting using the relative buoyancy of the hydrocarbon and caustic solution phases, or by centrifugation. The period for washing, particularly the residence time of the caustic solution and condensed hydrocarbons in a mixing zone, may be determined according to the level of contamination.

Since the washing of the condensed hydrocarbons may closely precede further processing of the condensed hydrocarbons in a steam cracker to produce an olefin stream, the caustic solution used for washing may comprise a fresh caustic solution, and preferably the caustic washing solution consists of fresh caustic solution. The caustic solution for washing the condensed hydrocarbons may have a pH from about 8 up to greater than 14, such as a pH from 10 to greater than 14, and especially a pH from 12 to greater than 14. Once used in the washing step, the spent caustic solution may be used in one or more upstream steps of the process of the invention as hereinbefore described.

In some embodiments, a stream of spent caustic solution from the washing step is split, such that a first portion of the spent caustic solution is recycled for use in the first scrubber where the condensed liquid hydrocarbon stream is scrubbed/separated and subsequently further recycled for use in the second scrubber where the non-condensed gaseous hydrocarbon stream is scrubbed, and a second portion of the spent caustic solution is recycled for use in the upstream pre-washing step where the comminuted plastics waste is initially cleaned prior to separation, and preferably is also used downstream of the pre-washing step in the separation of the pre-washed comminuted waste plastics material, such as in the flotation tanks, and subsequently further recycled. Since the resulting caustic-washed condensed hydrocarbon stream may include at least some entrained caustic washing solution, it is desirable to remove the same as introducing caustic solution into a steam cracker may be detrimental to its operation. Accordingly, in some embodiments, the caustic-washed condensed hydrocarbon stream may be subjected to a further washing step in which the stream is washed, or rather rinsed, with water. The rinsing water may be demineralised water, or water recycled from elsewhere in the process, for example, from downstream process steps, or water recycled from external sources.

Rinsing (washing) with water, such as demi-water, may be performed according to processes known in the art, for example, by stirring a mix of caustic-washed condensed hydrocarbon stream with water in one or more vessels followed by decanting, or by use of one or more extraction columns. The water from the washing step may be recycled for use in one or more upstream steps of the inventive process. For example, a stream of spent water from the washing step is split, such that a first portion of the spent water is recycled for use in the upstream caustic washing step, preferably as a diluent for the caustic, and a second portion of the spent water is recycled for use as make-up water in the step of separation of the pre-washed comminuted plastics waste, such as in the flotation tanks thereof, and/or for use as make-up water in the pre-washing step. As hereinbefore described, the make-up water from the separation step which is sourced from the rinsing step may be recycled yet further upstream for use in the pre-washing step.

Contrary to established practice, the washed hydrocarbon stream (otherwise sometimes referred to as pyrolysis oil) obtained from the raw plastics waste by means of the aforementioned process steps may be fed for steam cracking without a requirement to separate the stream into fractions beforehand. Thus, the process of the invention offers further savings over known processes where distillation has to be performed prior to steam cracking. Accordingly, steam crackers adapted to process hydrocarbons having boiling points up to about 650° C. may conveniently be used.

The washed waste plastics pyrolysis oil may potentially be used in a wide range of applications, including the production of renewable feedstock for chemicals and materials, as well as for transportation, and for industrial engines and turbines.

As will be understood, the process of the invention requires a relatively modest use of resources, in particular process integration whereby the water and the caustic solution required to prepare the condensed liquid hydrocarbon stream for use in a steam cracker for olefin production is recycled for use in a multitude of upstream steps involved in processing the raw plastics waste, reduces the overall impact on utilities. The process of the invention involving conversion of raw plastics waste to a hydrocarbon feed for use in a steam cracker presents opportunities for reducing operational costs and increasing the viability of plastics recycling. Such incentives are increasingly important to support a circular economy.

Throughout the specification, any reference to a particular embodiment or various embodiments means that a particular feature or group of features or characteristics described in connection with those described embodiments is included in at least one embodiment. Thus, statements referencing one or more embodiments are not necessarily all referring to the same embodiment.

Similarly, it should be appreciated that in the above description of embodiments, various features are sometimes grouped together in a single embodiment, figure, or description thereof, for the purpose of brevity. However, inventive aspects of the invention may lie in a combination of fewer than all the features of any single foregoing disclosed embodiment, and the invention in its broadest form is defined only by the features expressly recited in the claims.

1. A process for converting plastics waste into pyrolysis oil for feeding to a steam cracker, said process comprising the steps of:
a) pre-washing a stream of comminuted waste plastics in a washing liquid comprising washing water and caustic solution:
b) separating the pre-washed comminuted waste plastics to provide a stream of polyolefin-enriched washed comminuted plastics waste:
c) optionally drying the stream of polyolefin-enriched washed comminuted plastics waste:
d) thermally cracking the stream of polyolefin-enriched washed comminuted plastics waste to produce a vaporised hydrocarbon stream:
e) condensing the vaporised hydrocarbon stream into a liquid hydrocarbon stream and gaseous hydrocarbon stream:
f) washing the liquid hydrocarbon stream with caustic solution:
g) separating the liquid hydrocarbon stream from the caustic solution to produce a stream of caustic-washed liquid hydrocarbon and a stream of spent caustic solution; and
h) rinsing the caustic-washed liquid hydrocarbon stream with water;
i) separating the rinsed liquid hydrocarbon stream from the rinsing water to produce a stream of pyrolysis oil for further processing by steam cracking and a stream of spent water,
wherein:
a first portion of the spent water stream from step i) is combined with fresh caustic and used as caustic solution in step f) and a second portion of the spent water stream from step i) is used as washing water in step a), and
a first portion of the spent caustic solution from step g) is used as caustic solution in step a).

2. The process of claim 1, wherein in step b) separation is performed by passing the stream of polyolefin-enriched pre-washed comminuted plastics waste through a series of tanks containing flotation liquids of increasing density, and wherein the flotation liquids comprise spent water from step i) as a lower density flotation liquid, spent caustic solution from step g) as a higher density flotation liquid, and optionally mixture(s) thereof as intermediate density flotation liquid(s).

3. The process of claim 2, wherein the washing liquid used in step a) comprises spent water and spent caustic solution from the flotation tanks.

4. The process according to claim 1, wherein prior to the caustic washing step f), the liquid hydrocarbon stream from step e) is scrubbed by contacting the liquid hydrocarbon stream with a second portion of spent caustic solution from step g) in a first scrubber.

5. The process according to claim 4, wherein the liquid hydrocarbon stream from step e) is further subjected to stream stripping to remove light hydrocarbon components and thereby increase the flashpoint of the liquid hydrocarbon stream.

6. The process according to claim 3, wherein the gaseous hydrocarbon stream from step e), and any light hydrocarbon components stripped from the liquid hydrocarbon stream, is scrubbed by contacting the gaseous hydrocarbon stream and any stripped light hydrocarbon components with spent caustic solution discharged from the first scrubber in a second scrubber.

7. The process according to claim 1, wherein the comminuted waste plastics is prepared by the steps of:
removing non-plastics material from a waste stream having a plastics content to provide a waste plastics stream:
sorting the waste plastics stream to provide a waste plastics stream enriched in polyolefin-based waste plastics; and
comminuting the polyolefin-enriched waste plastics stream in one or more stages to provide comminuted plastics waste having an average diameter size of about 25 mm or less.

8. The process according to claim 1, comprising a further step:
j) feeding the stream of pyrolysis oil from step i) to a steam cracker and converting the pyrolysis oil stream into an olefin stream.

9. A process for steam cracking a hydrocarbon feed, wherein the hydrocarbon feed comprises pyrolysis oil recovered in a process according to claim 1.

10. A process for steam cracking a hydrocarbon feed, comprising the steps of:
Recovering pyrolysis oil from plastics waste in a process according to claim 1; and
steam cracking a hydrocarbon feed which comprises the pyrolysis oil as recovered in the preceding step.
